(19) United States
(12) Patent Application Publication
(10) Pub. No.: US 2019/0108030 A1
(43) Pub. Date: Apr. 11, 2019

(54) SYSTEMS, APPARATUSES, AND METHODS FOR BLENDING TWO SOURCE OPERANDS INTO A SINGLE DESTINATION USING A WRITEMASK

(71) Applicant: Intel Corporation, Santa Clara, CA (US)

(72) Inventors: Jesus CORBAL SAN ADRIAN, King City, OR (US); Bret L. TOLL, Hillsboro, OR (US); Robert C. VALENTINE, Kiryat Tivon (IL); Jeffrey G. WIEDEMEIER, Austin, TX (US); Sridhar SAMUDRALA, Austin, TX (US); Milind Baburao GIRKAR, Sunnyvale, CA (US); Andrew Thomas FORSYTH, Kirkland, WA (US); Elmoustapha OULD-AHMED-VALL, Chandler, AZ (US); Dennis R. BRADFORD, Portland, OR (US); Lisa K. WU, New York, NY (US)

(21) Appl. No.: 16/145,160

(22) Filed: Sep. 27, 2018

Related U.S. Application Data
(63) Continuation of application No. 13/078,864, filed on Apr. 1, 2011.

(51) Int. Cl. G06F 9/30

(52) U.S. Cl. CPC G06F 9/30192; G06F 9/30043; G06F 9/30036; G06F 9/30032; G06F 9/30018

(57) ABSTRACT

Embodiments of systems, apparatuses, and methods for performing a blend instruction in a computer processor are described. In some embodiments, the execution of a blend instruction causes a data element-by-element selection of data elements of first and second source operands using the corresponding bit positions of a writemask as a selector between the first and second operands and storage of the selected data elements into the destination at the corresponding position in the destination.

### CROSS REFERENCE TO RELATED APPLICATION

The present application is a continuation of co-pending U.S. patent application Ser. No. 13/078,864, filed on Apr. 1, 2011, entitled “SYSTEMS, APPARATUSES, AND METHODS FOR BLENDING TWO SOURCE OPERANDS INTO A SINGLE DESTINATION USING A WRITEMASK”, which is hereby incorporated by reference in its entirety and for all purposes.

### FIELD OF INVENTION

The field of invention relates generally to computer processor architecture, and, more specifically, to instructions which when executed cause a particular result.

### BACKGROUND

Merging data from vector sources based on control-flow information is a common issue of vector based architectures. For example, to vectorize the following code one needs: 1) a way to generate a vector of Booleans that indicate whether a[i]>0 is true and 2) a way to, based on that vector of Booleans, select either value from two sources (A[i] or B[i]) and write the contents into a different destinations (C[i]).

For (i=0; i<N; i++)
{
C[i] = (a[i]>0? A[i] : B[i];
}

### BRIEF DESCRIPTION OF THE DRAWINGS

The present invention is illustrated by way of example and not limitation in the figures of the accompanying drawings, in which like references indicate similar elements and in which:

FIG. 1 illustrates an example of a blend instruction's execution.

FIG. 2 illustrates another example of a blend instruction's execution.

FIG. 3 illustrates an example of pseudo code of a blend instruction.

FIG. 4 illustrates an embodiment of the use of a blend instruction in a processor.

FIG. 5 illustrates an embodiment of a method for processing a blend instruction.

FIG. 6 illustrates an embodiment of a method for processing a blend instruction.

FIG. 7A is a block diagram illustrating a generic vector friendly instruction format and class A instruction templates thereof according to embodiments of the invention.

FIG. 7B is a block diagram illustrating the generic vector friendly instruction format and class B instruction templates thereof according to embodiments of the invention.

FIG. 8A is a block diagram illustrating an exemplary specific vector friendly instruction format according to embodiments of the invention. FIG. 8B is a block diagram illustrating a full opcode field. FIG. 8C is a block diagram illustrating a register index field.

FIG. 9 is a block diagram of a register architecture according to one embodiment of the invention.

FIG. 10A is a block diagram of a single CPU core, along with its connection to the on-die interconnect network and with its local subset of the level 2 (L2) cache, according to embodiments of the invention.

FIG. 10B is an exploded view of part of the CPU core in FIG. 10A according to embodiments of the invention.

FIG. 11 is a block diagram illustrating an exemplary out-of-order architecture according to embodiments of the invention.

FIG. 12 is a block diagram of a system in accordance with one embodiment of the invention.

FIG. 13 is a block diagram of a second system in accordance with an embodiment of the invention.

FIG. 14 is a block diagram of a third system in accordance with an embodiment of the invention.

FIG. 15 is a block diagram of a SoC in accordance with an embodiment of the invention.

FIG. 16 is a block diagram of a single core processor and a multicore processor with integrated memory controller and graphics according to embodiments of the invention.

FIG. 17 is a block diagram contrasting the use of a software instruction converter to convert binary instructions in a source instruction set to binary instructions in a target instruction set according to embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

### Blend

Below are embodiments of an instruction generically called “blend,” and embodiments of systems, architectures, instruction formats etc. that may be used to execute such an instruction, that is beneficial in several different areas including what was described in the background. The execution of a blend instruction efficiently deals with the second part of the earlier described problem as it takes one mask register containing true/false bits from the result of, say, a comparison of a vector of elements, and based on those bits, it is able to select between the elements of two distinctive vector sources. In other words, the execution of a blend instruction causes a processor to perform an element-by-element blending between two sources using a writemask as a selector between those sources. The result of is written into a destination register. In some embodiments, at least one of the sources is a register such as a 128-, 256-, 512-bit vector register, etc. In some embodiments, at least one of the source operands is a collection of data elements associated with a starting memory location. Additionally, in some embodiments data elements of one or both sources go through a data transformation such as swizzle, broadcast, conversion, etc. (examples will be discussed herein) prior to any blending. Examples of writemask registers are detailed later.

An exemplary format of this instruction is “VBLENDMPS zmm1 {k1}, zmm2, zmm3/m512, offset,” where the operands zmm1, zmm2, and zmm3 are vector registers (such as 128-, 256-, 512-bit registers, etc.), k1 is a writemask operand (such as a 16-bit register like those detailed later), and m512 is a memory operand stored either in a register or as an immediate. ZMM1 is the destination operand and ZMM2 and ZMM3/m512 are the source operands. The offset, if any, is used to determine the memory address from the value in the register or immediate. Whatever is retrieved from memory is a collection consecutive bits starting from the memory address and may one of several sizes (128-, 256-, 512-bit, etc.) depending on the size of the destination register—the size is generally the same size as the destination register. In some embodiments, the writemask is also of a different size (8 bits, 32 bits, etc.). Additionally, in some embodiments, not all bits of the writemask are utilized by the instruction as will be detailed below. VBLENDMPS is the instruction's opcode. Typically, each operand is explicitly defined in the instruction. The size of the data elements may be defined in the “prefix” of the instruction such as through the use of an indication of data granularity bit like “W” described later. In most embodiments, W will indicate that each data elements are either 32 or 64 bits. If the data elements are 32 bits in size, and the sources are 512 bits in size, then there are sixteen (16) data elements per source.

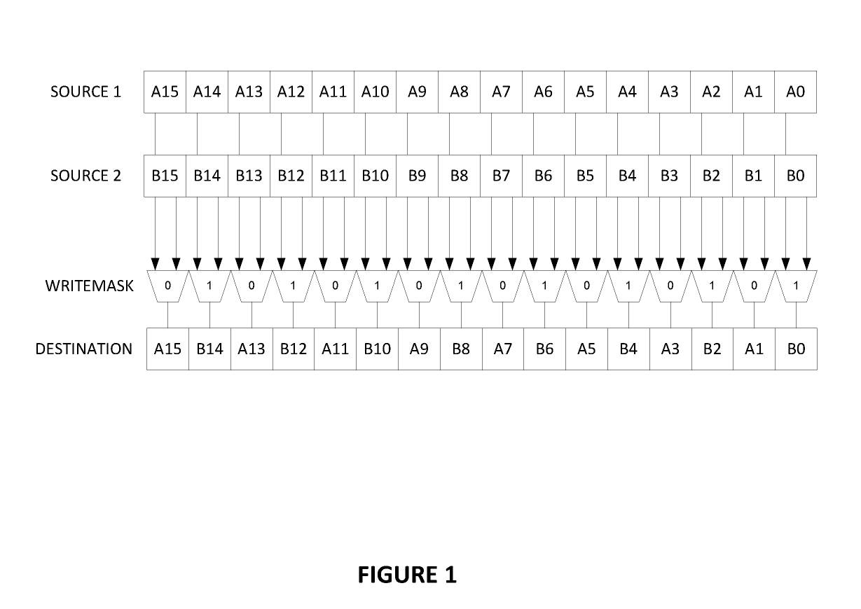

An example of a blend instruction's execution is illustrated in FIG. 1. In this example, there are two sources each having 16 data elements. In most cases, one of these sources is a register (for this example, source 1 is treated as being a 512-bit register such as a ZMM register with 16 32-bit data elements, however, other data element and register sizes may be used such as XMM and YMM registers and 16- or 64-bit data elements). The other source is either a register or a memory location (in this illustration source 2 is the other source). If the second source is a memory location, in most embodiments it is placed into a temporary register prior to any blending of the sources. Additionally, data elements of the memory location may undergo a data transformation prior to that placement into the temporary register. The mask pattern shown is 0x5555.

In this example, for each bit position of the writemask that has a value of “1” it is an indication that the corresponding data element of the first source (source 1) should be written into the corresponding data element position of the destination register. Accordingly, the first, third, fifth, etc. bit positions of source 1 (A0, A2, A4, etc.) are written into the first, third, fifth, etc. data element positions of the destination. Where the writemask has a “0” value, the data element of the second source is written into the corresponding data element position of the destination. Of course, the use of “1” and “0” could be flipped depending upon the implementation. Additionally, while this figure and above description considers the respective first positions to be the least significant positions, in some embodiments the first positions are the most significant positions.

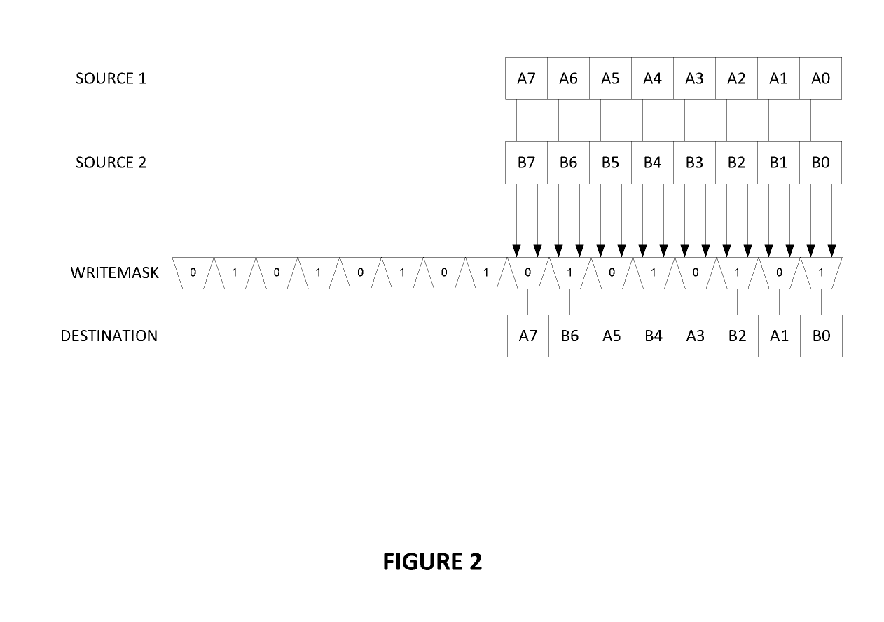

FIG. 2 illustrates another example of a blend instruction's execution. The difference between this figure and FIG. 1 is that each source only has 8 data elements (for example, the sources are 512-bit registers with 8 64-bit data elements each). In this scenario, with a 16-bit writemask not all bits of the writemask are used. In this instance only the least significant bits are used as there are not 16 data elements of each source to be merged.

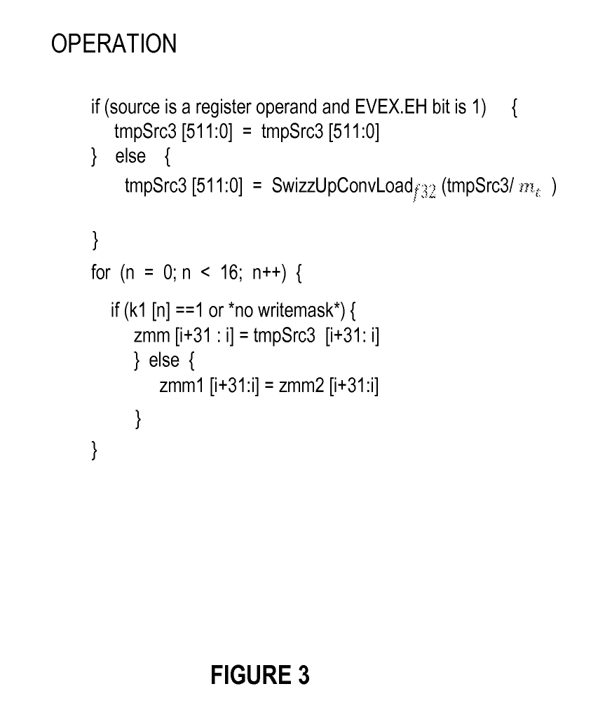

FIG. 3 illustrates an example of pseudo code of a blend instruction.

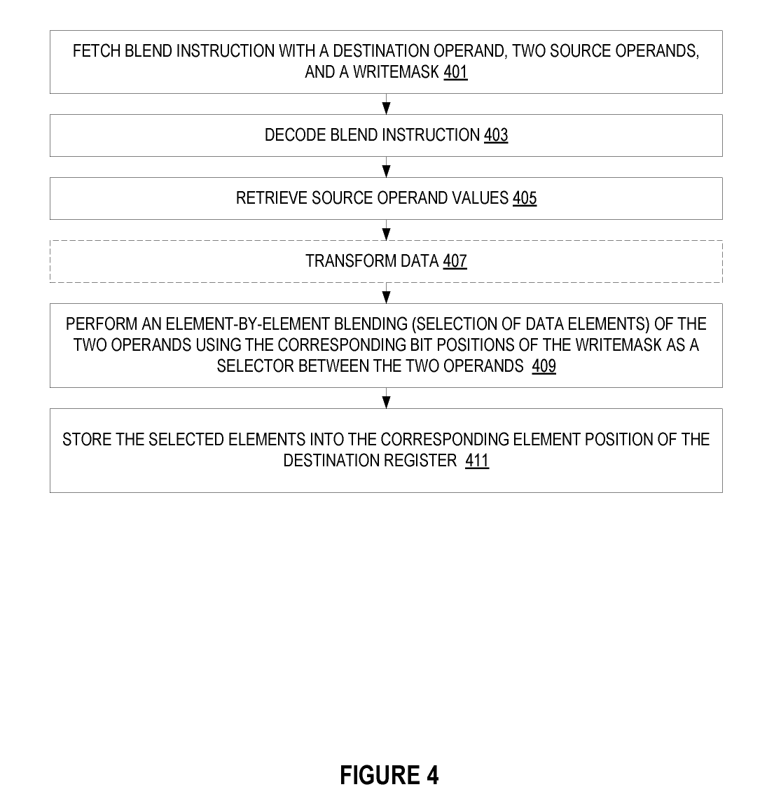

FIG. 4 illustrates an embodiment of the use of a blend instruction in a processor. A blend instruction with a destination operand, a two source operands, an offset (if any), and a writemask is fetched at 401. In some embodiments, the destination operand is a 512-bit vector register (such as ZMM1) and the writemask is a 16-bit register (such as a “k” writemask register detailed later). At least one of the source operands may be a memory source operand.

The blend instruction is decoded at 403. Depending on the instruction's format, a variety of data may be interpreted at this stage such as if there is to be a data transformation, which registers to write to and retrieve, what memory address to access, etc.

The source operand values are retrieved/read at 405. If both sources are registers then those registers are read. If one or both of the source operands is a memory operand, then the data elements associated with that operand are retrieved. In some embodiments, data elements from memory are stored into a temporary register.

If there is any data element transformation to be performed (such as an upconversion, broadcast, swizzle, etc. which are detailed later) it may be performed at 407. For example, a 16-bit data element from memory may be upconverted into a 32-bit data element or data elements may be swizzled from one pattern to another (e.g., XYZW XYZW XYZW . . . XYZW to XXXXXXXX YYYYYYYY ZZZZZZZZZZ WWWWWWWW).

The blend instruction (or operations comprising such an instruction such as microoperations) is executed by execution resources at 409. This execution causes an element-by-element blending between two sources using a writemask as a selector between those sources. For example, data elements of the first and second sources are selected based on a corresponding bit value of the writemask. Examples of such a blending are illustrated in FIGS. 1 and 2.

The appropriate data elements of the source operands are stored into the destination register at 411. Again, examples of this are shown in FIGS. 1 and 2. While 409 and 411 have been illustrated separately, in some embodiments they are performed together as a part of the execution of the instruction.

While the above has been illustrated in one type of execution environment it is easily modified to fit in other environments such as the in-order and out-of-order environments detailed.

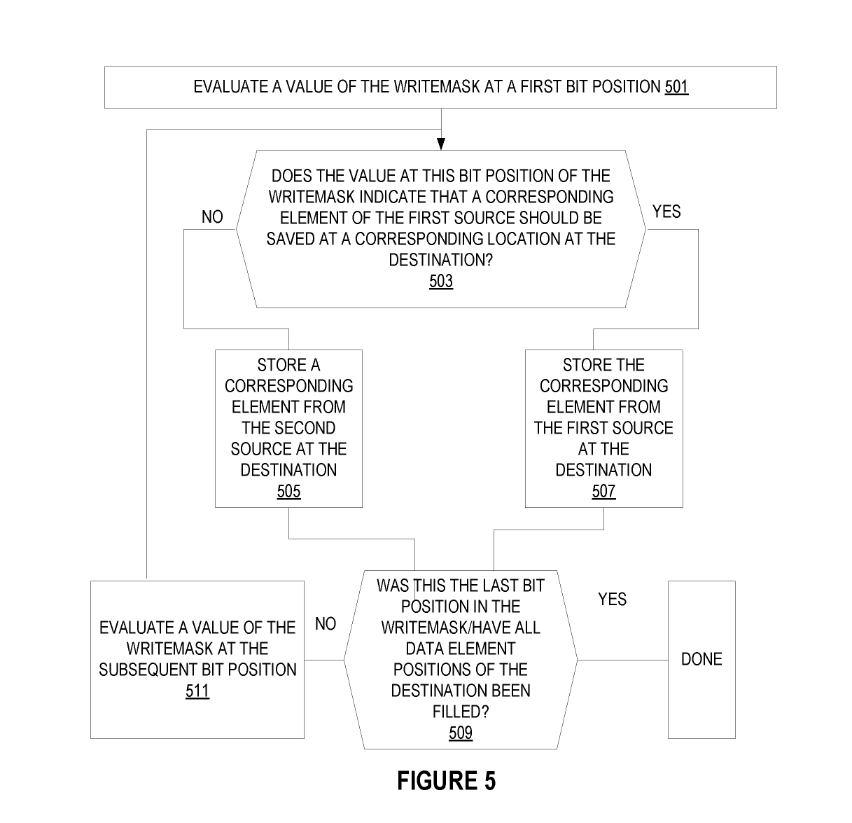

FIG. 5 illustrates an embodiment of a method for processing a blend instruction. In this embodiment it is assumed that some, if not all, of the operations 401-407 have been performed earlier, however, they are not shown in order to not obscure the details presented below. For example, the fetching and decoding are not shown, nor is the operand (sources and writemask) retrieval shown.

At 501, the value of the first bit position of the writemask is evaluated. For example, the value at writemask k1 [0] is determined. In some embodiments, the first bit position is the least significant bit position and in other embodiments it is the most significant bit position. The remaining discussion will describe the use of the first bit position being the least significant, however, the changes that would be made if it was the most significant would be readily understood by a person of ordinary skill in the art.

A determination of if the value at this bit position of the writemask indicates that a corresponding data element of the first source (the first data element) should be saved at a corresponding location of the destination is made at 503. If the first bit position indicates that the data element in the first position of the first source should be stored in the first position of the destination register, then it is stored at 507. Looking back at FIG. 1, the mask indicated that this would be the case and the first data element of the first source was stored in the first data element position of the destination register.

If the first bit position indicates that the data element in the first position of the first source should not be stored in the first position of the destination register, then the data element in the first position of the second source is stored at 505. Looking back at FIG. 1, the mask indicated that this would not have been the case.

A determination of if the evaluated writemask position was the last of the writemask or if all of the data element positions of the destination have been filled is made at 509. If true, then the operation is over. If not true, then the next bit position in the writemask is to be evaluated to determine its value at 511.

A determination of if the value at this subsequent bit position of the writemask indicates that a corresponding data element of the first source (the second data element) should be saved at a corresponding location of the destination is made at 503. This repeats until all bits in the mask have been exhausted or all of the data elements of the destination have been filled. The latter case may occur when, for example, the data element sizes are 64 bits, the destination is 512 bits, and the writemask has 16 bits. In that instance, only 8 bits of the writemask would be necessary, but the blend instruction would have completed. Put another way, the number of bits of the writemask to use is dependent on the writemask size and the number of data elements in each source.

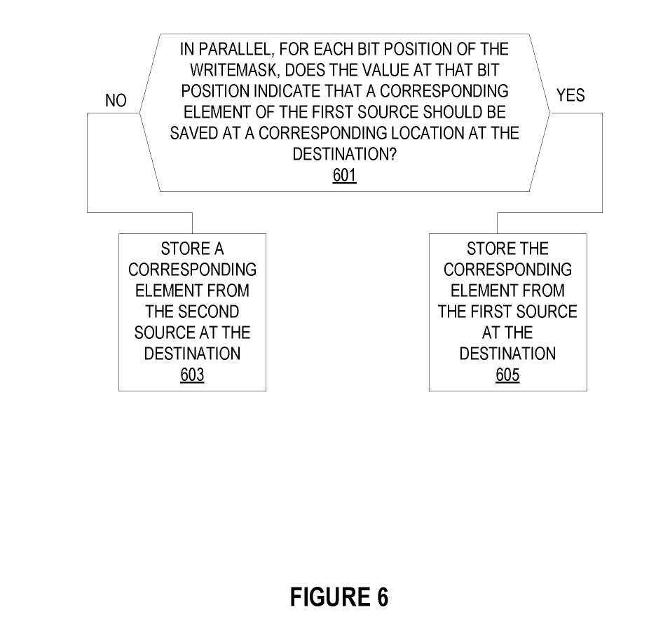

FIG. 6 illustrates an embodiment of a method for processing a blend instruction. In this embodiment it is assumed that some, if not all, of the operations 401-407 have been performed prior to 601. At 601, for each bit position of the writemask to be used, a determination of if the value at that bit position indicates that a corresponding data element of the first source should be saved at a corresponding location in the destination register.

For each bit position of the writemask that indicates that the data element of the first source should be saved in the destination register it is written into the appropriate location at 605. For each bit position of the writemask that indicates that the data element of the second source should be saved in the destination register it is written into the appropriate location at 603. In some embodiments, 603 and 605 are performed in parallel.

While FIGS. 5 and 6 have discussed making decisions based on a first source, either source may be used for the determination. Additionally, it should be clearly understood that when a data element of one source is not to be written that the corresponding data element of the other source is to be written into the destination register.

Intel Corporation's AVX introduced other versions of BLEND vector instructions based on either immediate values (VBLENDPS) or based on the sign-bits of the elements of a third vector source (VBLENDVPS) The first has the disadvantage that the blending information is static while the second has the disadvantage that the dynamic blending information comes from other vector register, causing extra register read pressure, storage waste (only 1 every 32 bits is actually useful for Boolean representation) and extra overhead (since predication information needs to be mapped into a true-data vector register). VBLENDMPS introduces the concept of blending values from two sources using predication information contained in a true mask register. This has the following advantages: it allows for variable blending, allows for blending using decoupled arithmetic and predicated logic components (arithmetic is performed on vectors, predication on masks; masks are being used to blend the arithmetic data based on control-flow info), alleviates read pressure on the vector register file (mask reads are cheaper and on a separated register file) and avoids wasting storage (storing Booleans on a vector is highly inefficient, since only 1-bit per element is actually needed—out of 32-bits/64-bits).

Embodiments of the instruction(s) detailed above are embodied may be embodied in a “generic vector friendly instruction format” which is detailed below. In other embodiments, such a format is not utilized and another instruction format is used, however, the description below of the writemask registers, various data transformations (swizzle, broadcast, etc.), addressing, etc. is generally applicable to the description of the embodiments of the instruction(s) above. Additionally, exemplary systems, architectures, and pipelines are detailed below. Embodiments of the instruction(s) above may be executed on such systems, architectures, and pipelines, but are not limited to those detailed.

A vector friendly instruction format is an instruction format that is suited for vector instructions (e.g., there are certain fields specific to vector operations). While embodiments are described in which both vector and scalar operations are supported through the vector friendly instruction format, alternative embodiments use only vector operations the vector friendly instruction format.

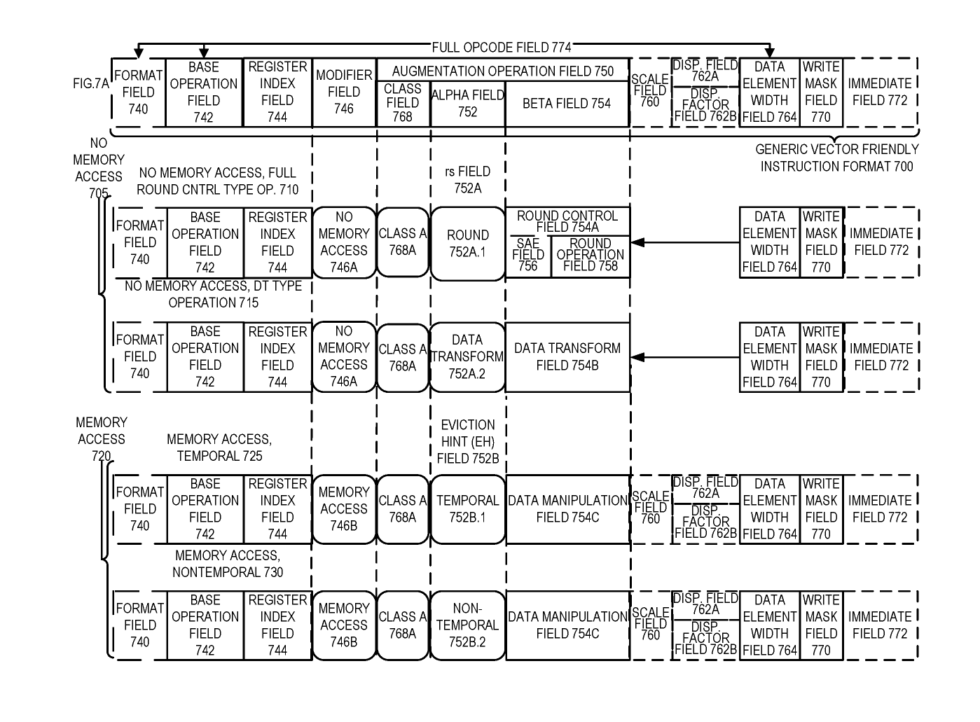

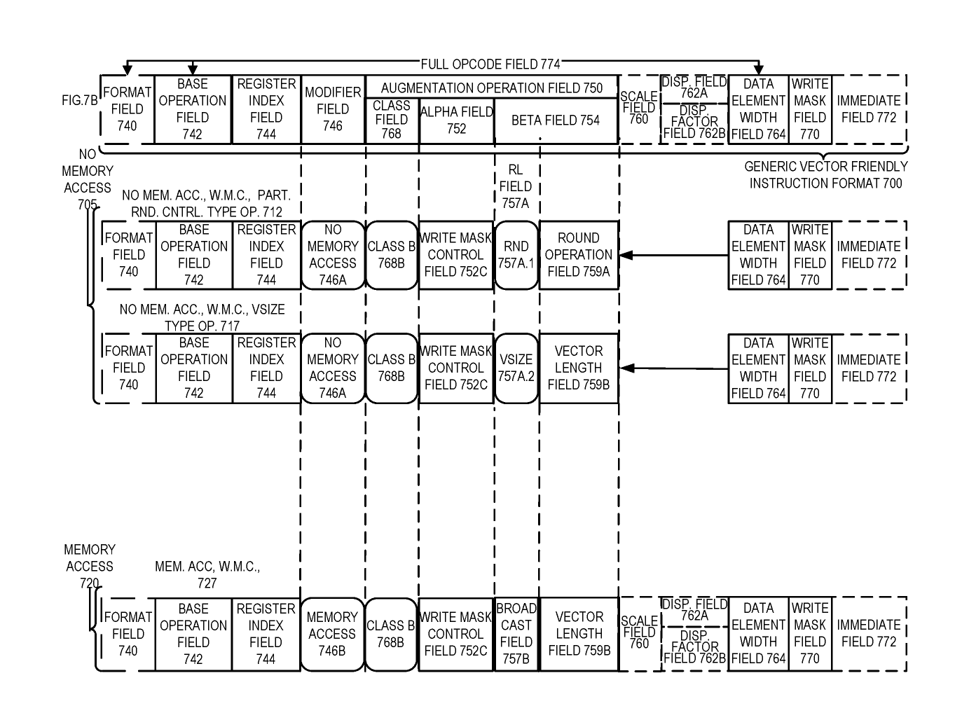

Exemplary Generic Vector Friendly Instruction Format—FIG. 7A-B

FIGS. 7A-B are block diagrams illustrating a generic vector friendly instruction format and instruction templates thereof according to embodiments of the invention. FIG. 7A is a block diagram illustrating a generic vector friendly instruction format and class A instruction templates thereof according to embodiments of the invention; while FIG. 7B is a block diagram illustrating the generic vector friendly instruction format and class B instruction templates thereof according to embodiments of the invention. Specifically, a generic vector friendly instruction format 700 for which are defined class A and class B instruction templates, both of which include no memory access 705 instruction templates and memory access 720 instruction templates. The term generic in the context of the vector friendly instruction format refers to the instruction format not being tied to any specific instruction set. While embodiments will be described in which instructions in the vector friendly instruction format operate on vectors that are sourced from either registers (no memory access 705 instruction templates) or registers/memory (memory access 720 instruction templates), alternative embodiments of the invention may support only one of these. Also, while embodiments of the invention will be described in which there are load and store instructions in the vector instruction format, alternative embodiments instead or additionally have instructions in a different instruction format that move vectors into and out of registers (e.g., from memory into registers, from registers into memory, between registers). Further, while embodiments of the invention will be described that support two classes of instruction templates, alternative embodiments may support only one of these or more than two.

While embodiments of the invention will be described in which the vector friendly instruction format supports the following: a 64 byte vector operand length (or size) with 32 bit (4 byte) or 64 bit (8 byte) data element widths (or sizes) (and thus, a 64 byte vector consists of either 16 doubleword-size elements or alternatively, 8 quadword-size elements); a 64 byte vector operand length (or size) with 16 bit (2 byte) or 8 bit (1 byte) data element widths (or sizes); a 32 byte vector operand length (or size) with 32 bit (4 byte), 64 bit (8 byte), 16 bit (2 byte), or 8 bit (1 byte) data element widths (or sizes); and a 16 byte vector operand length (or size) with 32 bit (4 byte), 64 bit (8 byte), 16 bit (2 byte), or 8 bit (1 byte) data element widths (or sizes); alternative embodiments may support more, less and/or different vector operand sizes (e.g., 756 byte vector operands) with more, less, or different data element widths (e.g., 128 bit (16 byte) data element widths).

The class A instruction templates in FIG. 7A include: 1) within the no memory access 705 instruction templates there is shown a no memory access, full round control type operation 710 instruction template and a no memory access, data transform type operation 715 instruction template; and 2) within the memory access 720 instruction templates there is shown a memory access, temporal 725 instruction template and a memory access, non-temporal 730 instruction template. The class B instruction templates in FIG. 7B include: 1) within the no memory access 705 instruction templates there is shown a no memory access, write mask control, partial round control type operation 712 instruction template and a no memory access, write mask control, vsize type operation 717 instruction template; and 2) within the memory access 720 instruction templates there is shown a memory access, write mask control 727 instruction template.

Format

The generic vector friendly instruction format 700 includes the following fields listed below in the order illustrated in FIGS. 7A-B.

Format field 740—a specific value (an instruction format identifier value) in this field uniquely identifies the vector friendly instruction format, and thus occurrences of instructions in the vector friendly instruction format in instruction streams. Thus, the content of the format field 740 distinguish occurrences of instructions in the first instruction format from occurrences of instructions in other instruction formats, thereby allowing for the introduction of the vector friendly instruction format into an instruction set that has other instruction formats. As such, this field is optional in the sense that it is not needed for an instruction set that has only the generic vector friendly instruction format.

Base operation field 742—its content distinguishes different base operations. As described later herein, the base operation field 742 may include and/or be part of an opcode field.

Register index field 744—its content, directly or through address generation, specifies the locations of the source and destination operands, be they in registers or in memory. These include a sufficient number of bits to select N registers from a PxQ (e.g. 32×912) register file. While in one embodiment N may be up to three sources and one destination register, alternative embodiments may support more or less sources and destination registers (e.g., may support up to two sources where one of these sources also acts as the destination, may support up to three sources where one of these sources also acts as the destination, may support up to two sources and one destination). While in one embodiment P=32, alternative embodiments may support more or less registers (e.g., 16). While in one embodiment Q=912 bits, alternative embodiments may support more or less bits (e.g., 128, 1024).

Modifier field 746—its content distinguishes occurrences of instructions in the generic vector instruction format that specify memory access from those that do not; that is, between no memory access 705 instruction templates and memory access 720 instruction templates. Memory access operations read and/or write to the memory hierarchy (in some cases specifying the source and/or destination addresses using values in registers), while non-memory access operations do not (e.g., the source and destinations are registers). While in one embodiment this field also selects between three different ways to perform memory address calculations, alternative embodiments may support more, less, or different ways to perform memory address calculations.

Augmentation operation field 750—its content distinguishes which one of a variety of different operations to be performed in addition to the base operation. This field is context specific. In one embodiment of the invention, this field is divided into a class field 768, an alpha field 752, and a beta field 754. The augmentation operation field allows common groups of operations to be performed in a single instruction rather than 2, 3 or 4 instructions. Below are some examples of instructions (the nomenclature of which are described in more detail later herein) that use the augmentation field 750 to reduce the number of required instructions.

| | Instructions Sequences according to |
|---|---|
| Prior Instruction Sequences | on Embodiment of the Invention |
| vaddps ymm0, ymm1, ymm2 | vaddps zmm0, zmm1, zmm2 |
| vpshufd ymm2, ymm2, 0 × 55 | vaddps zmm0, zmm1, zmm2 |
| vaddps ymm0, ymm1, ymm2 | {bbbb} |
| vpmovsxbd ymm2, [rax] | vaddps zmm0, zmm1, |
| vcvtdq2ps ymm2, ymm2 | [rax]{sint8} |
| vaddps ymm0, ymm1, ymm2 | |
| vpmovsxbd ymm3, [rax] | vaddps zmm1{k5}, zmm2, |
| vcvtdq2ps ymm3, ymm3 | [rax]{sint8} |
| vaddps ymm4, ymm2, ymm3 | |
| vblendvps ymm1, ymm5, | |
| ymm1, ymm4 | |
| vmaskmovps ymm1, ymm7, [rbx] | vmovaps zmm1 {k7}, [rbx] |
| vbroadcastss ymm0, [rax] | vaddps zmm2{k7}{z}, zmm1, |
| vaddps ymm2, ymm0, ymm1 | [rax]{1toN} |
| vblendvps ymm2, ymm2, ymm1, | |
| ymm7 | |

Where [rax] is the base pointer to be used for address generation, and where {} indicates a conversion operation specified by the data manipulation filed (described in more detail later here).

Scale field 760—its content allows for the scaling of the index field's content for memory address generation (e.g., for address generation that uses 2^{scale}*index+base).

Displacement Field 762A—its content is used as part of memory address generation (e.g., for address generation that uses 2^{scale}*index+base+displacement).

Displacement Factor Field 762B (note that the juxtaposition of displacement field 762A directly over displacement factor field 762B indicates one or the other is used)—its content is used as part of address generation; it specifies a displacement factor that is to be scaled by the size of a memory access (N)—where N is the number of bytes in the memory access (e.g., for address generation that uses 2^{scale}*index+base+scaled displacement). Redundant low-order bits are ignored and hence, the displacement factor field's content is multiplied by the memory operands total size (N) in order to generate the final displacement to be used in calculating an effective address. The value of N is determined by the processor hardware at runtime based on the full opcode field 774 (described later herein) and the data manipulation field 754C as described later herein. The displacement field 762A and the displacement factor field 762B are optional in the sense that they are not used for the no memory access 705 instruction templates and/or different embodiments may implement only one or none of the two.

Data element width field 764—its content distinguishes which one of a number of data element widths is to be used (in some embodiments for all instructions; in other embodiments for only some of the instructions). This field is optional in the sense that it is not needed if only one data element width is supported and/or data element widths are supported using some aspect of the opcodes.

Write mask field 770—its content controls, on a per data element position basis, whether that data element position in the destination vector operand reflects the result of the base operation and augmentation operation. Class A instruction templates support merging-writemasking, while class B instruction templates support both merging- and zeroing-writemasking. When merging, vector masks allow any set of elements in the destination to be protected from updates during the execution of any operation (specified by the base operation and the augmentation operation); in other one embodiment, preserving the old value of each element of the destination where the corresponding mask bit has a 0. In contrast, when zeroing vector masks allow any set of elements in the destination to be zeroed during the execution of any operation (specified by the base operation and the augmentation operation); in one embodiment, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the write mask field 770 allows for partial vector operations, including loads, stores, arithmetic, logical, etc. Also, this masking can be used for fault suppression (i.e., by masking the destination's data element positions to prevent receipt of the result of any operation that may/will cause a fault—e.g., assume that a vector in memory crosses a page boundary and that the first page but not the second page would cause a page fault, the page fault can be ignored if all data element of the vector that lie on the first page are masked by the write mask). Further, write masks allow for “vectorizing loops” that contain certain types of conditional statements. While embodiments of the invention are described in which the write mask field's 770 content selects one of a number of write mask registers that contains the write mask to be used (and thus the write mask field's 770 content indirectly identifies that masking to be performed), alternative embodiments instead or additional allow the mask write field's 770 content to directly specify the masking to be performed. Further, zeroing allows for performance improvements when: 1) register renaming is used on instructions whose destination operand is not also a source (also call non-ternary instructions) because during the register renaming pipeline stage the destination is no longer an implicit source (no data elements from the current destination register need be copied to the renamed destination register or somehow carried along with the operation because any data element that is not the result of operation (any masked data element) will be zeroed); and 2) during the write back stage because zeros are being written.

Immediate field 772—its content allows for the specification of an immediate. This field is optional in the sense that is it not present in an implementation of the generic vector friendly format that does not support immediate and it is not present in instructions that do not use an immediate.

Instruction Template Class Selection

Class field 768—its content distinguishes between different classes of instructions. With reference to FIGS. 2A-B, the contents of this field select between class A and class B instructions. In FIGS. 7A-B, rounded corner squares are used to indicate a specific value is present in a field (e.g., class A 768A and class B 768B for the class field 768 respectively in FIGS. 7A-B).

No-Memory Access Instruction Templates of Class A

In the case of the non-memory access 705 instruction templates of class A, the alpha field 752 is interpreted as an RS field 752A, whose content distinguishes which one of the different augmentation operation types are to be performed (e.g., round 752A.1 and data transform 752A.2 are respectively specified for the no memory access, round type operation 710 and the no memory access, data transform type operation 715 instruction templates), while the beta field 754 distinguishes which of the operations of the specified type is to be performed. In FIG. 7, rounded corner blocks are used to indicate a specific value is present (e.g., no memory access 746A in the modifier field 746; round 752A.1 and data transform 752A.2 for alpha field 752/rs field 752A). In the no memory access 705 instruction templates, the scale field 760, the displacement field 762A, and the displacement scale filed 762B are not present.

No-Memory Access Instruction Templates—Full Round Control Type Operation

In the no memory access full round control type operation 710 instruction template, the beta field 754 is interpreted as a round control field 754A, whose content(s) provide static rounding. While in the described embodiments of the invention the round control field 754A includes a suppress all floating point exceptions (SAE) field 756 and a round operation control field 758, alternative embodiments may support may encode both these concepts into the same field or only have one or the other of these concepts/fields (e.g., may have only the round operation control field 758).

SAE field 756—its content distinguishes whether or not to disable the exception event reporting; when the SAE field's 756 content indicates suppression is enabled, a given instruction does not report any kind of floating-point exception flag and does not raise any floating point exception handler.

Round operation control field 758—its content distinguishes which one of a group of rounding operations to perform (e.g., Round-up, Round-down, Round-towards-zero and Round-to-nearest). Thus, the round operation control field 758 allows for the changing of the rounding mode on a per instruction basis, and thus is particularly useful when this is required. In one embodiment of the invention where a processor includes a control register for specifying rounding modes, the round operation control field's 750 content overrides that register value (Being able to choose the rounding mode without having to perform a save-modify-restore on such a control register is advantageous).

No Memory Access Instruction Templates—Data Transform Type Operation

In the no memory access data transform type operation 715 instruction template, the beta field 754 is interpreted as a data transform field 754B, whose content distinguishes which one of a number of data transforms is to be performed (e.g., no data transform, swizzle, broadcast).

Memory Access Instruction Templates of Class A

In the case of a memory access 720 instruction template of class A, the alpha field 752 is interpreted as an eviction hint field 752B, whose content distinguishes which one of the eviction hints is to be used (in FIG. 7A, temporal 752B.1 and non-temporal 752B.2 are respectively specified for the memory access, temporal 725 instruction template and the memory access, non-temporal 730 instruction template), while the beta field 754 is interpreted as a data manipulation field 754C, whose content distinguishes which one of a number of data manipulation operations (also known as primitives) is to be performed (e.g., no manipulation; broadcast; up conversion of a source; and down conversion of a destination). The memory access 720 instruction templates include the scale field 760, and optionally the displacement field 762A or the displacement scale field 762B.

Vector Memory Instructions perform vector loads from and vector stores to memory, with conversion support. As with regular vector instructions, vector memory instructions transfer data from/to memory in a data element-wise fashion, with the elements that are actually transferred dictated by the contents of the vector mask that is selected as the write mask. In FIG. 7A, rounded corner squares are used to indicate a specific value is present in a field (e.g., memory access 746B for the modifier field 746; temporal 752B.1 and non-temporal 752B.2 for the alpha field 752/eviction hint field 752B)

Memory Access Instruction Templates—Temporal

Temporal data is data likely to be reused soon enough to benefit from caching. This is, however, a hint, and different processors may implement it in different ways, including ignoring the hint entirely.

Memory Access Instruction Templates—Non-Temporal

Non-temporal data is data unlikely to be reused soon enough to benefit from caching in the 1st-level cache and should be given priority for eviction. This is, however, a hint, and different processors may implement it in different ways, including ignoring the hint entirely.

Instruction Templates of Class B

In the case of the instruction templates of class B, the alpha field 752 is interpreted as a write mask control (Z) field 752C, whose content distinguishes whether the write masking controlled by the write mask field 770 should be a merging or a zeroing.

No-Memory Access Instruction Templates of Class B

In the case of the non-memory access 705 instruction templates of class B, part of the beta field 754 is interpreted as an RL field 757A, whose content distinguishes which one of the different augmentation operation types are to be performed (e.g., round 757A.1 and vector length (VSIZE) 757A.2 are respectively specified for the no memory access, write mask control, partial round control type operation 712 instruction template and the no memory access, write mask control, VSIZE type operation 717 instruction template), while the rest of the beta field 754 distinguishes which of the operations of the specified type is to be performed. In FIG. 7, rounded corner blocks are used to indicate a specific value is present (e.g., no memory access 746A in the modifier field 746; round 757A.1 and VSIZE 757A.2 for the RL field 757A). In the no memory access 705 instruction templates, the scale field 760, the displacement field 762A, and the displacement scale filed 762B are not present.

No-Memory Access Instruction Templates—Write Mask Control, Partial Round Control Type Operation

In the no memory access, write mask control, partial round control type operation 710 instruction template, the rest of the beta field 754 is interpreted as a round operation field 759A and exception event reporting is disabled (a given instruction does not report any kind of floating-point exception flag and does not raise any floating point exception handler).

Round operation control field 759A—just as round operation control field 758, its content distinguishes which one of a group of rounding operations to perform (e.g., Round-up, Round-down, Round-towards-zero and Round-to-nearest). Thus, the round operation control field 759A allows for the changing of the rounding mode on a per instruction basis, and thus is particularly useful when this is required. In one embodiment of the invention where a processor includes a control register for specifying rounding modes, the round operation control field's 750 content overrides that register value (Being able to choose the rounding mode without having to perform a save-modify-restore on such a control register is advantageous).

No Memory Access Instruction Templates—Write Mask Control, VSIZE Type Operation

In the no memory access, write mask control, VSIZE type operation 717 instruction template, the rest of the beta field 754 is interpreted as a vector length field 759B, whose content distinguishes which one of a number of data vector length is to be performed on (e.g., 128, 756, or 912 byte).

Memory Access Instruction Templates of Class B

In the case of a memory access 720 instruction template of class A, part of the beta field 754 is interpreted as a broadcast field 757B, whose content distinguishes whether or not the broadcast type data manipulation operation is to be performed, while the rest of the beta field 754 is interpreted the vector length field 759B. The memory access 720 instruction templates include the scale field 760, and optionally the displacement field 762A or the displacement scale field 762B.

Additional Comments Regarding Fields

With regard to the generic vector friendly instruction format 700, a full opcode field 774 is shown including the format field 740, the base operation field 742, and the data element width field 764. While one embodiment is shown where the full opcode field 774 includes all of these fields, the full opcode field 774 includes less than all of these fields in embodiments that do not support all of them. The full opcode field 774 provides the operation code.

The augmentation operation field 750, the data element width field 764, and the write mask field 770 allow these features to be specified on a per instruction basis in the generic vector friendly instruction format.

The combination of write mask field and data element width field create typed instructions in that they allow the mask to be applied based on different data element widths.

The instruction format requires a relatively small number of bits because it reuses different fields for different purposes based on the contents of other fields. For instance, one perspective is that the modifier field's content choses between the no memory access 705 instructions templates on FIGS. 7A-B and the memory access 7250 instruction templates on FIGS. 7A-B; while the class field 768's content choses within those non-memory access 705 instruction templates between instruction templates 710/715 of FIG. 7A and 712/717 of FIG. 7B; and while the class field 768's content choses within those memory access 720 instruction templates between instruction templates 725/730 of FIG. 7A and 727 of FIG. 7B. From another perspective, the class field 768's content choses between the class A and class B instruction templates respectively of FIGS. 7A and B; while the modifier field's content choses within those class A instruction templates between instruction templates 705 and 720 of FIG. 7A; and while the modifier field's content choses within those class B instruction templates between instruction templates 705 and 720 of FIG. 7B. In the case of the class field's content indicating a class A instruction template, the content of the modifier field 746 choses the interpretation of the alpha field 752 (between the rs field 752A and the EH field 752B. In a related manner, the contents of the modifier field 746 and the class field 768 chose whether the alpha field is interpreted as the rs field 752A, the EH field 752B, or the write mask control (Z) field 752C. In the case of the class and modifier fields indicating a class A no memory access operation, the interpretation of the augmentation field's beta field changes based on the rs field's content; while in the case of the class and modifier fields indicating a class B no memory access operation, the interpretation of the beta field depends on the contents of the RL field. In the case of the class and modifier fields indicating a class A memory access operation, the interpretation of the augmentation field's beta field changes based on the base operation field's content; while in the case of the class and modifier fields indicating a class B memory access operation, the interpretation of the augmentation field's beta field's broadcast field 757B changes based on the base operation field's contents. Thus, the combination of the base operation field, modifier field and the augmentation operation field allow for an even wider variety of augmentation operations to be specified.

The various instruction templates found within class A and class B are beneficial in different situations. Class A is useful when zeroing-writemasking or smaller vector lengths are desired for performance reasons. For example, zeroing allows avoiding fake dependences when renaming is used since we no longer need to artificially merge with the destination; as another example, vector length control eases store-load forwarding issues when emulating shorter vector sizes with the vector mask. Class B is useful when it is desirable to: 1) allow floating point exceptions (i.e., when the contents of the SAE field indicate no) while using rounding-mode controls at the same time; 2) be able to use upconversion, swizzling, swap, and/or downconversion; 3) operate on the graphics data type. For instance, upconversion, swizzling, swap, downconversion, and the graphics data type reduce the number of instructions required when working with sources in a different format; as another example, the ability to allow exceptions provides full IEEE compliance with directed rounding-modes.

Exemplary Specific Vector Friendly Instruction Format

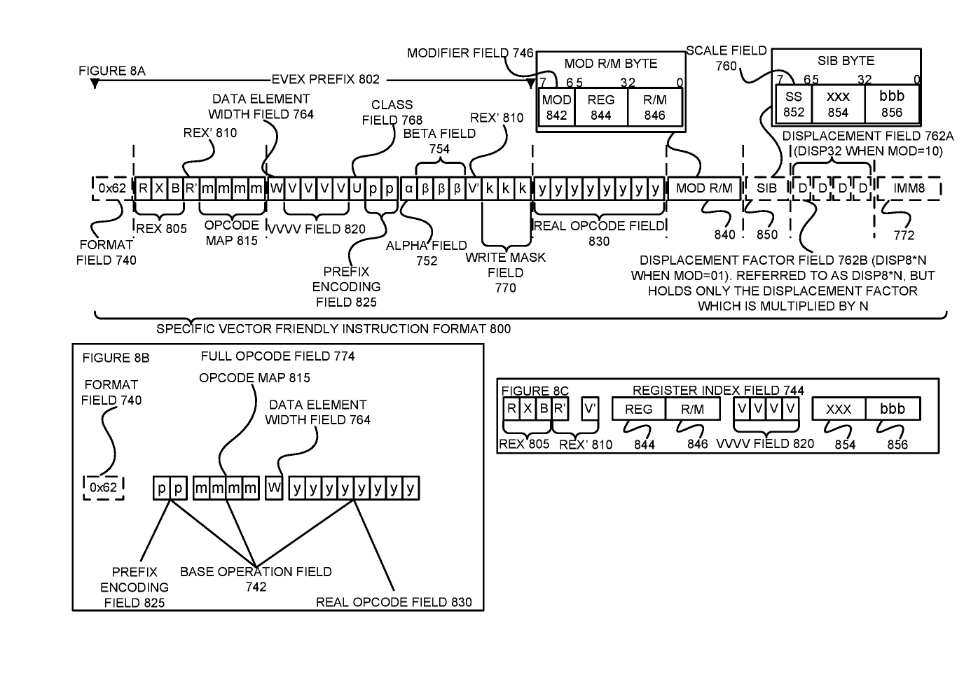

FIG. 8 is a block diagram illustrating an exemplary specific vector friendly instruction format according to embodiments of the invention. FIG. 8 shows a specific vector friendly instruction format 800 that is specific in the sense that it specifies the location, size, interpretation, and order of the fields, as well as values for some of those fields. The specific vector friendly instruction format 800 may be used to extend the x86 instruction set, and thus some of the fields are similar or the same as those used in the existing x86 instruction set and extension thereof (e.g., AVX). This format remains consistent with the prefix encoding field, real opcode byte field, MOD R/M field, SIB field, displacement field, and immediate fields of the existing x86 instruction set with extensions. The fields from FIG. 7 into which the fields from FIG. 8 map are illustrated.

It should be understand that although embodiments of the invention are described with reference to the specific vector friendly instruction format 800 in the context of the generic vector friendly instruction format 700 for illustrative purposes, the invention is not limited to the specific vector friendly instruction format 800 except where claimed. For example, the generic vector friendly instruction format 700 contemplates a variety of possible sizes for the various fields, while the specific vector friendly instruction format 800 is shown as having fields of specific sizes. By way of specific example, while the data element width field 764 is illustrated as a one bit field in the specific vector friendly instruction format 800, the invention is not so limited (that is, the generic vector friendly instruction format 700 contemplates other sizes of the data element width field 764).

Format—FIG. 8

The generic vector friendly instruction format 700 includes the following fields listed below in the order illustrated in FIGS. 8A-C.

EVEX Prefix (Bytes 0-3)

EVEX Prefix 802—is encoded in a four-byte form.

Format Field 740 (EVEX Byte 0, bits [7:0])—the first byte (EVEX Byte 0) is the format field 740 and it contains 0x62 (the unique value used for distinguishing the vector friendly instruction format in one embodiment of the invention).

The second-fourth bytes (EVEX Bytes 1-3) include a number of bit fields providing specific capability.

REX field 805 (EVEX Byte 1, bits [7-5])—consists of a EVEX.R bit field (EVEX Byte 1, bit [7]R), EVEX.X bit field (EVEX byte 1, bit [6]—X), and 757BEX byte 1, bit[5]—B). The EVEX.R, EVEX.X, and EVEX.B bit fields provide the same functionality as the corresponding VEX bit fields, and are encoded using 1 s complement form, i.e. ZMM0 is encoded as 1111B, ZMM15 is encoded as 0000B. Other fields of the instructions encode the lower three bits of the register indexes as is known in the art (rrr, xxx, and bbb), so that Rrrr, Xxxx, and Bbbb may be formed by adding EVEX.R, EVEX.X, and EVEX.B.

REX' field 810—this is the first part of the REX' field 810 and is the EVEX.R′ bit field (EVEX Byte 1, bit [4]—R′) that is used to encode either the upper 16 or lower 16 of the extended 32 register set. In one embodiment of the invention, this bit, along with others as indicated below, is stored in bit inverted format to distinguish (in the well-known x86 32-bit mode) from the BOUND instruction, whose real opcode byte is 62, but does not accept in the MOD RIM field (described below) the value of 11 in the MOD field; alternative embodiments of the invention do not store this and the other indicated bits below in the inverted format. A value of 1 is used to encode the lower 16 registers. In other words, R′Rrrr is formed by combining EVEX.R′, EVEX.R, and the other RRR from other fields.

Opcode map field 815 (EVEX byte 1, bits [3:0]—mmmm)—its content encodes an implied leading opcode byte (0F, 0F 38, or 0F 3).

Data element width field 764 (EVEX byte 2, bit [7]—W)—is represented by the notation EVEX.W. EVEX.W is used to define the granularity (size) of the datatype (either 32-bit data elements or 64-bit data elements).

EVEX.vvvv 820 (EVEX Byte 2, bits [6:3]-vvvv)—the role of EVEX.vvvv may include the following: 1) EVEX.vvvv encodes the first source register operand, specified in inverted (1 s complement) form and is valid for instructions with 2 or more source operands; 2) EVEX.vvvv encodes the destination register operand, specified in 1 s complement form for certain vector shifts; or 3) EVEX.vvvv does not encode any operand, the field is reserved and should contain 1111b. Thus, EVEX.vvvv field 820 encodes the 4 low-order bits of the first source register specifier stored in inverted (1 s complement) form. Depending on the instruction, an extra different EVEX bit field is used to extend the specifier size to 32 registers.

EVEX.0 768 Class field (EVEX byte 2, bit [2]-U)—If EVEX.U=0, it indicates class A or EVEX.U0; if EVEX.U=1, it indicates class B or EVEX.U1.

Prefix encoding field 825 (EVEX byte 2, bits [1:0]-pp)—provides additional bits for the base operation field. In addition to providing support for the legacy SSE instructions in the EVEX prefix format, this also has the benefit of compacting the SIMD prefix (rather than requiring a byte to express the SIMD prefix, the EVEX prefix requires only 2 bits). In one embodiment, to support legacy SSE instructions that use a SIMD prefix (66H, F2H, F3H) in both the legacy format and in the EVEX prefix format, these legacy SIMD prefixes are encoded into the SIMD prefix encoding field; and at runtime are expanded into the legacy SIMD prefix prior to being provided to the decoder's PLA (so the PLA can execute both the legacy and EVEX format of these legacy instructions without modification). Although newer instructions could use the EVEX prefix encoding field's content directly as an opcode extension, certain embodiments expand in a similar fashion for consistency but allow for different meanings to be specified by these legacy SIMD prefixes. An alternative embodiment may redesign the PLA to support the 2 bit SIMD prefix encodings, and thus not require the expansion.

Alpha field 752 (EVEX byte 3, bit [7]—EH; also known as EVEX.EH, EVEX.rs, EVEX.RL, EVEX.write mask control, and EVEX.N; also illustrated with α)—as previously described, this field is context specific. Additional description is provided later herein.

Beta field 754 (EVEX byte 3, bits [6:4]-SSS, also known as EVEX.s₂₋₀, EVEX.r₂₋₀, EVEX.rr1, EVEX.LL0, EVEX.LLB; also illustrated with βββ)—as previously described, this field is context specific. Additional description is provided later herein.

REX' field 810—this is the remainder of the REX' field and is the EVEX.V′ bit field (EVEX Byte 3, bit [3]—V′) that may be used to encode either the upper 16 or lower 16 of the extended 32 register set. This bit is stored in bit inverted format. A value of 1 is used to encode the lower 16 registers. In other words, V′VVVV is formed by combining EVEX.V′, EVEX.vvvv.

Write mask field 770 (EVEX byte 3, bits [2:0]-kkk)—its content specifies the index of a register in the write mask registers as previously described. In one embodiment of the invention, the specific value EVEX kkk=000 has a special behavior implying no write mask is used for the particular instruction (this may be implemented in a variety of ways including the use of a write mask hardwired to all ones or hardware that bypasses the masking hardware).

Real Opcode Field 830 (Byte 4)

This is also known as the opcode byte. Part of the opcode is specified in this field.

MOD R/M Field 840 (Byte 5)

Modifier field 746 (MODR/M.MOD, bits [7-6]—MOD field 842)—As previously described, the MOD field's 842 content distinguishes between memory access and non-memory access operations. This field will be further described later herein.

MODR/M.reg field 844, bits [5-3]—the role of ModR/M.reg field can be summarized to two situations: ModR/M.reg encodes either the destination register operand or a source register operand, or ModR/M.reg is treated as an opcode extension and not used to encode any instruction operand.

MODR/M.r/m field 846, bits [2-0]—The role of ModR/M.r/m field may include the following: ModR/M.r/m encodes the instruction operand that references a memory address, or ModR/M.r/m encodes either the destination register operand or a source register operand.

Scale, Index, Base (SIB) Byte (Byte 6) 850.

Scale field 760 (SIB.SS, bits [7-6] 852—As previously described, the scale field's 760 content is used for memory address generation. This field will be further described later herein.

SIB.xxx 854 (bits [5-3] and SIB.bbb 856 (bits [2-0])—the contents of these fields have been previously referred to with regard to the register indexes Xxxx and Bbbb.

Displacement Byte(s) (Byte 7 or Bytes 7-10)

Displacement field 762A (Bytes 7-10)—when MOD field 842 contains 10, bytes 7-10 are the displacement field 762A, and it works the same as the legacy 32-bit displacement (disp32) and works at byte granularity.

Displacement factor field 762B (Byte 7)—when MOD field 842 contains 01, byte 7 is the displacement factor field 762B. The location of this field is that same as that of the legacy x86 instruction set 8-bit displacement (disp8), which works at byte granularity. Since disp8 is sign extended, it can only address between −128 and 127 bytes offsets; in terms of 64 byte cache lines, disp8 uses 8 bits that can be set to only four really useful values −128, −64, 0, and 64; since a greater range is often needed, disp32 is used; however, disp32 requires 4 bytes. In contrast to disp8 and disp32, the displacement factor field 762B is a reinterpretation of disp8; when using displacement factor field 762B, the actual displacement is determined by the content of the displacement factor field multiplied by the size of the memory operand access (N). This type of displacement is referred to as disp8*N. This reduces the average instruction length (a single byte of used for the displacement but with a much greater range). Such compressed displacement is based on the assumption that the effective displacement is multiple of the granularity of the memory access, and hence, the redundant low-order bits of the address offset do not need to be encoded. In other words, the displacement factor field 762B substitutes the legacy x86 instruction set 8-bit displacement. Thus, the displacement factor field 762B is encoded the same way as an x86 instruction set 8-bit displacement (so no changes in the ModRM/SIB encoding rules) with the only exception that disp8 is overloaded to disp8*N. In other words, there are no changes in the encoding rules or encoding lengths but only in the interpretation of the displacement value by hardware (which needs to scale the displacement by the size of the memory operand to obtain a byte-wise address offset).

Immediate

Immediate field 772 operates as previously described.

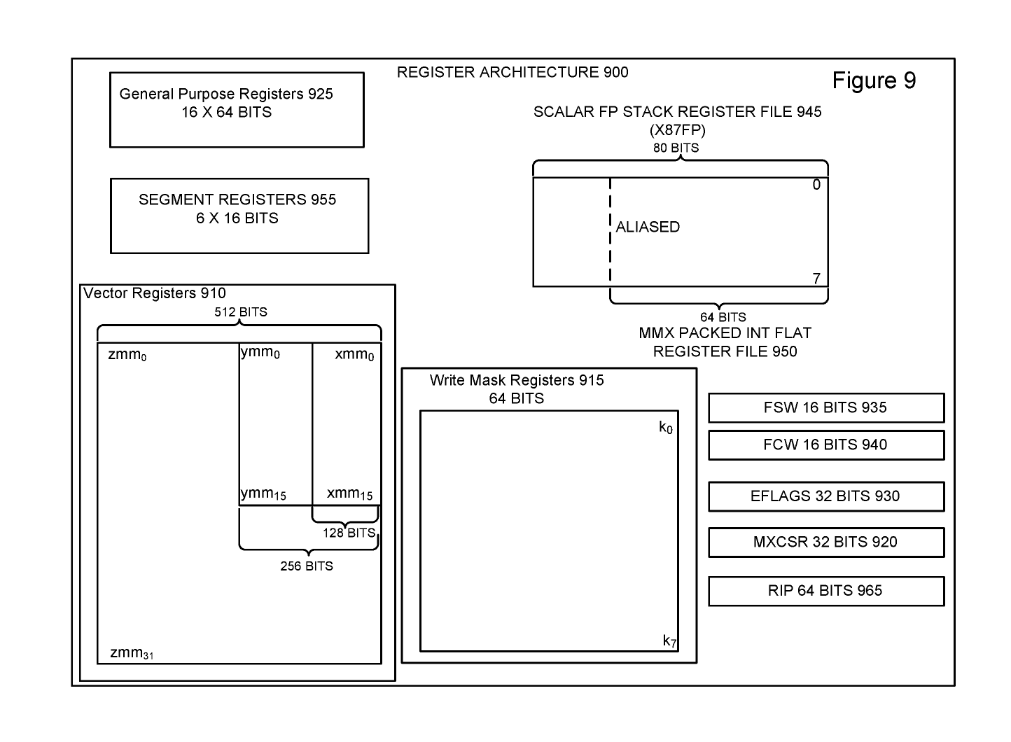

Exemplary Register Architecture—FIG. 9

FIG. 9 is a block diagram of a register architecture 900 according to one embodiment of the invention. The register files and registers of the register architecture are listed below:

Vector register file 910—in the embodiment illustrated, there are 32 vector registers that are 912 bits wide; these registers are referenced as zmm0 through zmm31. The lower order 756 bits of the lower 16 zmm registers are overlaid on registers ymm0-16. The lower order 128 bits of the lower 16 zmm registers (the lower order 128 bits of the ymm registers) are overlaid on registers xmm0-15. The specific vector friendly instruction format 800 operates on these overlaid register file as illustrated in the below tables.

| Adjustable | | | |
|---|---|---|---|
| Vector Length | Class | Operations | Registers |
| Instruction | A (FIG. 7A; | 710, 715, 725, | zmm registers |
| Templates that | U = 0) | 730 | (the vector |
| do not include | | | length is 64 byte) |
| the vector length | B (FIG. 7B; | 712 | zmm registers |
| field 759B | U = 1) | | (the vector |
| | | | length is 64 byte) |
| Instruction | B (FIG. 7B; | 717, 727 | zmm, ymm, or |
| Templates that | U = 1) | | xmm registers |
| do include the | | | (the vector |
| vector length | | | length is 64 byte, |
| field 759B | | | 32 byte, or 16 |
| | | | byte) depending |
| | | | on the vector |
| | | | length field 759B |

In other words, the vector length field 759B selects between a maximum length and one or more other shorter lengths, where each such shorter length is half the length of the preceding length; and instructions templates without the vector length field 759B operate on the maximum vector length. Further, in one embodiment, the class B instruction templates of the specific vector friendly instruction format 800 operate on packed or scalar single/double-precision floating point data and packed or scalar integer data. Scalar operations are operations performed on the lowest order data element position in an zmm/ymm/xmm register; the higher order data element positions are either left the same as they were prior to the instruction or zeroed depending on the embodiment.

Write mask registers 915—in the embodiment illustrated, there are 8 write mask registers (k0 through k7), each 64 bits in size. As previously described, in one embodiment of the invention the vector mask register k0 cannot be used as a write mask; when the encoding that would normally indicate k0 is used for a write mask, it selects a hardwired write mask of 0xFFFF, effectively disabling write masking for that instruction.

Multimedia Extensions Control Status Register (MXCSR) 920—in the embodiment illustrated, this 32-bit register provides status and control bits used in floating-point operations.

General-purpose registers 925—in the embodiment illustrated, there are sixteen 64-bit general-purpose registers that are used along with the existing x86 addressing modes to address memory operands. These registers are referenced by the names RAX, RBX, RCX, RDX, RBP, RSI, RDI, RSP, and R8 through R15.

Extended flags (EFLAGS) register 930—in the embodiment illustrated, this 32 bit register is used to record the results of many instructions.

Floating Point Control Word (FCW) register 935 and Floating Point Status Word (FSW) register 940—in the embodiment illustrated, these registers are used by x87 instruction set extensions to set rounding modes, exception masks and flags in the case of the FCW, and to keep track of exceptions in the case of the FSW.

Scalar floating point stack register file (x87 stack) 945 on which is aliased the MMX packed integer flat register file 950—in the embodiment illustrated, the x87 stack is an eight-element stack used to perform scalar floating-point operations on 32/64/80-bit floating point data using the x87 instruction set extension; while the MMX registers are used to perform operations on 64-bit packed integer data, as well as to hold operands for some operations performed between the MMX and XMM registers.

Segment registers 955—in the illustrated embodiment, there are six 16 bit registers use to store data used for segmented address generation.

RIP register 965—in the illustrated embodiment, this 64 bit register that stores the instruction pointer.

Alternative embodiments of the invention may use wider or narrower registers. Additionally, alternative embodiments of the invention may use more, less, or different register files and registers.

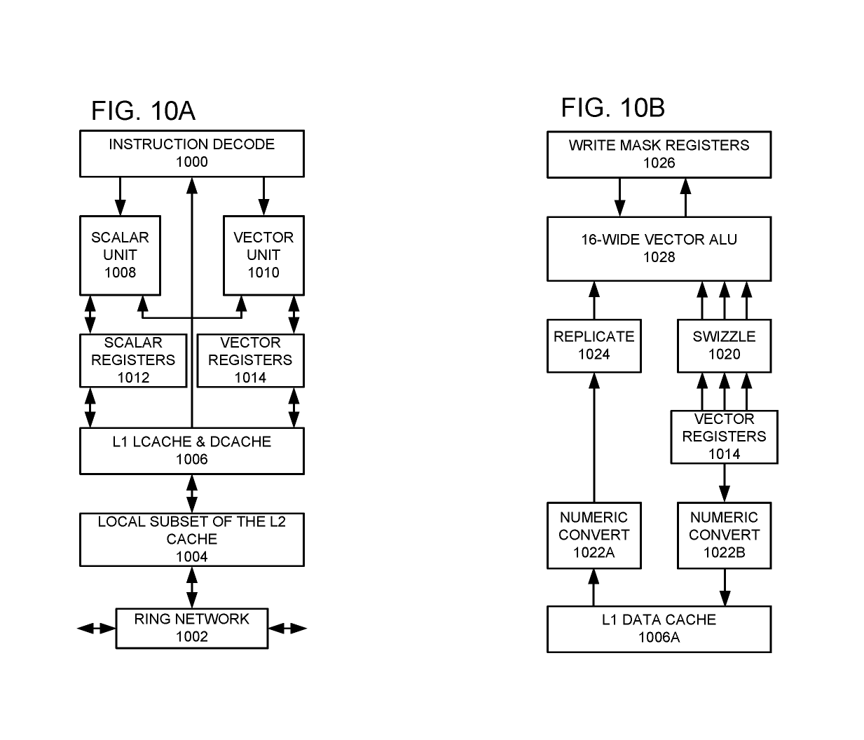

Exemplary In-Order Processor Architecture—FIGS. 10A-10B

FIGS. 10A-B illustrate a block diagram of an exemplary in-order processor architecture. These exemplary embodiments are designed around multiple instantiations of an in-order CPU core that is augmented with a wide vector processor (VPU). Cores communicate through a high-bandwidth interconnect network with some fixed function logic, memory I/O interfaces, and other necessary I/O logic, depending on the e12t application. For example, an implementation of this embodiment as a stand-alone GPU would typically include a PCIe bus.

FIG. 10A is a block diagram of a single CPU core, along with its connection to the on-die interconnect network 1002 and with its local subset of the level 2 (L2) cache 1004, according to embodiments of the invention. An instruction decoder 1000 supports the x86 instruction set with an extension including the specific vector instruction format 800. While in one embodiment of the invention (to simplify the design) a scalar unit 1008 and a vector unit 1010 use separate register sets (respectively, scalar registers 1012 and vector registers 1014) and data transferred between them is written to memory and then read back in from a level 1 (L1) cache 1006, alternative embodiments of the invention may use a different approach (e.g., use a single register set or include a communication path that allow data to be transferred between the two register files without being written and read back).

The L1 cache 1006 allows low-latency accesses to cache memory into the scalar and vector units. Together with load-op instructions in the vector friendly instruction format, this means that the L1 cache 1006 can be treated somewhat like an extended register file. This significantly improves the performance of many algorithms, especially with the eviction hint field 752B.

The local subset of the L2 cache 1004 is part of a global L2 cache that is divided into separate local subsets, one per CPU core. Each CPU has a direct access path to its own local subset of the L2 cache 1004. Data read by a CPU core is stored in its L2 cache subset 1004 and can be accessed quickly, in parallel with other CPUs accessing their own local L2 cache subsets. Data written by a CPU core is stored in its own L2 cache subset 1004 and is flushed from other subsets, if necessary. The ring network ensures coherency for shared data.

FIG. 10B is an exploded view of part of the CPU core in FIG. 10A according to embodiments of the invention. FIG. 10B includes an L1 data cache 1006A part of the L1 cache 1004, as well as more detail regarding the vector unit 1010 and the vector registers 1014. Specifically, the vector unit 1010 is a 16-wide vector processing unit (VPU) (see the 16-wide ALU 1028), which executes integer, single-precision float, and double-precision float instructions. The VPU supports swizzling the register inputs with swizzle unit 1020, numeric conversion with numeric convert units 1022A-B, and replication with replication unit 1024 on the memory input. Write mask registers 1026 allow predicating the resulting vector writes.

Register data can be swizzled in a variety of ways, e.g. to support matrix multiplication. Data from memory can be replicated across the VPU lanes. This is a common operation in both graphics and non-graphics parallel data processing, which significantly increases the cache efficiency.

The ring network is bi-directional to allow agents such as CPU cores, L2 caches and other logic blocks to communicate with each other within the chip. Each ring data-path is 912-bits wide per direction.

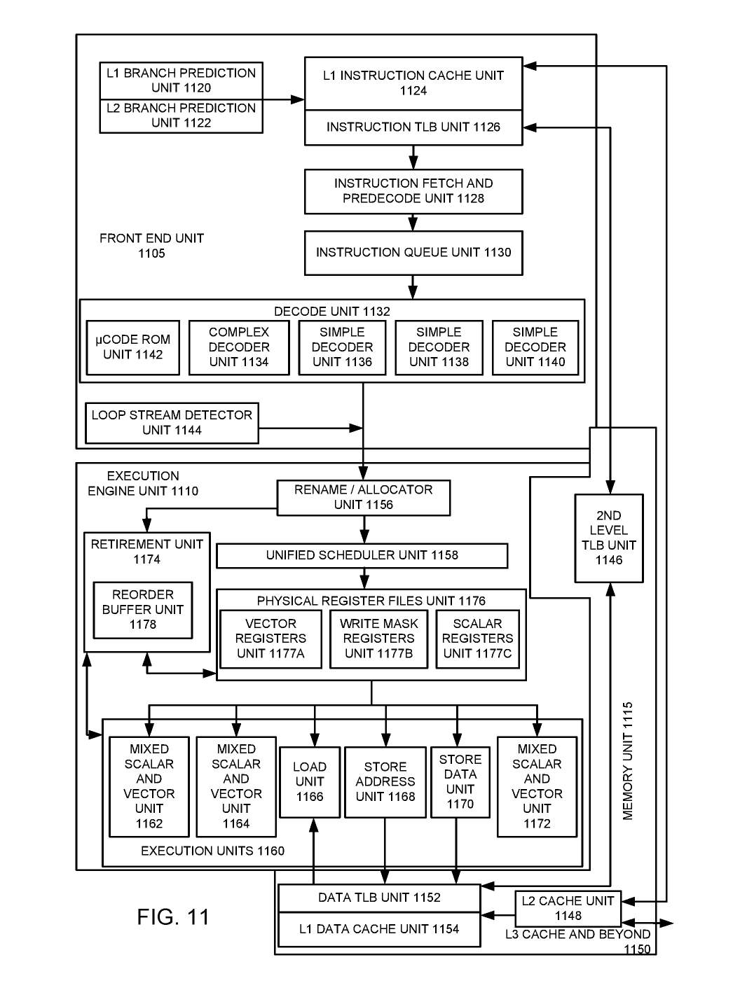

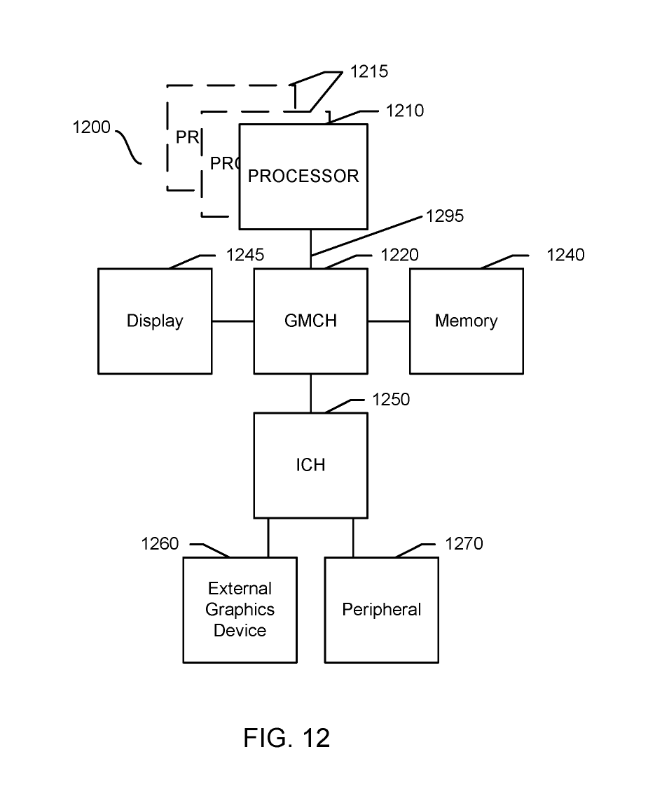

Exemplary Out-of-order Architecture—FIG. 11

FIG. 11 is a block diagram illustrating an exemplary out-of-order architecture according to embodiments of the invention. Specifically, FIG. 11 illustrates a well-known exemplary out-of-order architecture that has been modified to incorporate the vector friendly instruction format and execution thereof. In FIG. 11 arrows denotes a coupling between two or more units and the direction of the arrow indicates a direction of data flow between those units. FIG. 11 includes a front end unit 1105 coupled to an execution engine unit 1110 and a memory unit 1115; the execution engine unit 1110 is further coupled to the memory unit 1115.

The front end unit 1105 includes a level 1 (L1) branch prediction unit 1120 coupled to a level 2 (L2) branch prediction unit 1122. The L1 and L2 brand prediction units 1120 and 1122 are coupled to an L1 instruction cache unit 1124. The L1 instruction cache unit 1124 is coupled to an instruction translation lookaside buffer (TLB) 1126 which is further coupled to an instruction fetch and predecode unit 1128. The instruction fetch and predecode unit 1128 is coupled to an instruction queue unit 1130 which is further coupled a decode unit 1132. The decode unit 1132 comprises a complex decoder unit 1134 and three simple decoder units 1136, 1138, and 1140. The decode unit 1132 includes a micro-code ROM unit 1142. The decode unit 1132 may operate as previously described above in the decode stage section. The L1 instruction cache unit 1124 is further coupled to an L2 cache unit 1148 in the memory unit 1115. The instruction TLB unit 1126 is further coupled to a second level TLB unit 1146 in the memory unit 1115. The decode unit 1132, the micro-code ROM unit 1142, and a loop stream detector unit 1144 are each coupled to a rename/allocator unit 1156 in the execution engine unit 1110.

The execution engine unit 1110 includes the rename/allocator unit 1156 that is coupled to a retirement unit 1174 and a unified scheduler unit 1158. The retirement unit 1174 is further coupled to execution units 1160 and includes a reorder buffer unit 1178. The unified scheduler unit 1158 is further coupled to a physical register files unit 1176 which is coupled to the execution units 1160. The physical register files unit 1176 comprises a vector registers unit 1177A, a write mask registers unit 1177B, and a scalar registers unit 1177C; these register units may provide the vector registers 1110, the vector mask registers 1115, and the general purpose registers 1125; and the physical register files unit 1176 may include additional register files not shown (e.g., the scalar floating point stack register file 1145 aliased on the MMX packed integer flat register file 1150). The execution units 1160 include three mixed scalar and vector units 1162, 1164, and 1172; a load unit 1166; a store address unit 1168; a store data unit 1170. The load unit 1166, the store address unit 1168, and the store data unit 1170 are each coupled further to a data TLB unit 1152 in the memory unit 1115.

The memory unit 1115 includes the second level TLB unit 1146 which is coupled to the data TLB unit 1152. The data TLB unit 1152 is coupled to an L1 data cache unit 1154. The L1 data cache unit 1154 is further coupled to an L2 cache unit 1148. In some embodiments, the L2 cache unit 1148 is further coupled to L3 and higher cache units 1150 inside and/or outside of the memory unit 1115.

By way of example, the exemplary out-of-order architecture may implement a process pipeline as follows: 1) the instruction fetch and predecode unit 1128 perform the fetch and length decoding stages; 2) the decode unit 1132 performs the decode stage; 3) the rename/allocator unit 1156 performs the allocation stage and renaming stage; 4) the unified scheduler 1158 performs the schedule stage; 5) the physical register files unit 1176, the reorder buffer unit 1178, and the memory unit 1115 perform the register read/memory read stage 1930; the execution units 1160 perform the execute/data transform stage; 6) the memory unit 1115 and the reorder buffer unit 1178 perform the write back/memory write stage 1960; 7) the retirement unit 1174 performs the ROB read stage; 8) various units may be involved in the exception handling stage; and 9) the retirement unit 1174 and the physical register files unit 1176 perform the commit stage.

Exemplary Single Core and Multicore Processors

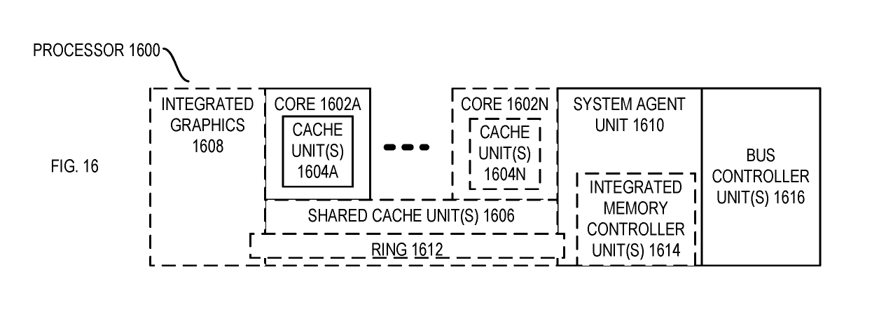

FIG. 16 is a block diagram of a single core processor and a multicore processor with integrated memory controller and graphics according to embodiments of the invention. The solid lined boxes in FIG. 16 illustrate a processor 1600 with a single core 1602A, a system agent 1610, a set of one or more bus controller units 1616, while the optional addition of the dashed lined boxes illustrates an alternative processor 1600 with multiple cores 1602A-N, a set of one or more integrated memory controller unit(s) 1614 in the system agent unit 1610, and an integrated graphics logic 1608.

The memory hierarchy includes one or more levels of cache within the cores, a set or one or more shared cache units 1606, and external memory (not shown) coupled to the set of integrated memory controller units 1614. The set of shared cache units 1606 may include one or more mid-level caches, such as level 2 (L2), level 3 (L3), level 4 (L4), or other levels of cache, a last level cache (LLC), and/or combinations thereof. While in one embodiment a ring based interconnect unit 1612 interconnects the integrated graphics logic 1608, the set of shared cache units 1604A-N, and the system agent unit 1610, alternative embodiments may use any number of well-known techniques for interconnecting such units.

In some embodiments, one or more of the cores 1602A-N are capable of multi-threading. The system agent 1610 includes those components coordinating and operating cores 1602A-N. The system agent unit 1610 may include for example a power control unit (PCU) and a display unit. The PCU may be or include logic and components needed for regulating the power state of the cores 1602A-N and the integrated graphics logic 1608. The display unit is for driving one or more externally connected displays.

The cores 1602A-N may be homogenous or heterogeneous in terms of architecture and/or instruction set. For example, some of the cores 1602A-N may be in order (e.g., like that shown in FIGS. 10A and 10B) while others are out-of-order (e.g., like that shown in FIG. 11). As another example, two or more of the cores 1602A-N may be capable of executing the same instruction set, while others may be capable of executing only a subset of that instruction set or a different instruction set. At least one of the cores is capable of executing the vector friendly instruction format described herein.

The processor may be a general-purpose processor, such as a Core™ i3, i5, i7, 2 Duo and Quad, Xeon™, or Itanium™ processor, which are available from Intel Corporation, of Santa Clara, Calif. Alternatively, the processor may be from another company. The processor may be a special-purpose processor, such as, for example, a network or communication processor, compression engine, graphics processor, co-processor, embedded processor, or the like. The processor may be implemented on one or more chips. The processor 1600 may be a part of and/or may be implemented on one or more substrates using any of a number of process technologies, such as, for example, BiCMOS, CMOS, or NMOS.

Exemplary Computer Systems and Processors

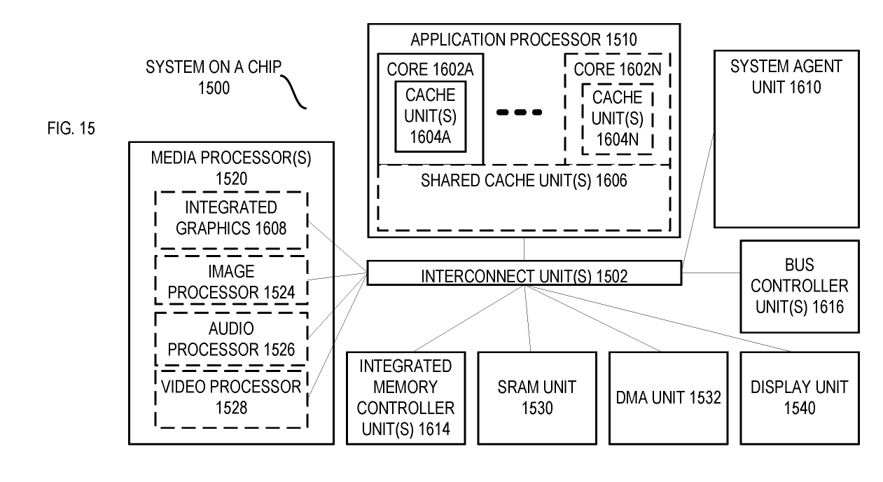

FIGS. 12-14 are exemplary systems suitable for including the processor 1600, while FIG. 15 is an exemplary system on a chip (SoC) that may include one or more of the cores 1602. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 12, shown is a block diagram of a system 1200 in accordance with one embodiment of the invention. The system 1200 may include one or more processors 1210, 1215, which are coupled to graphics memory controller hub (GMCH) 1220. The optional nature of additional processors 1215 is denoted in FIG. 12 with broken lines.

Each processor 1210, 1215 may be some version of processor 1600. However, it should be noted that it is unlikely that integrated graphics logic and integrated memory control units would exist in the processors 1210, 1215.

FIG. 12 illustrates that the GMCH 1220 may be coupled to a memory 1240 that may be, for example, a dynamic random access memory (DRAM). The DRAM may, for at least one embodiment, be associated with a non-volatile cache.

The GMCH 1220 may be a chipset, or a portion of a chipset. The GMCH 1220 may communicate with the processor(s) 1210, 1215 and control interaction between the processor(s) 1210, 1215 and memory 1240. The GMCH 1220 may also act as an accelerated bus interface between the processor(s) 1210, 1215 and other elements of the system 1200. For at least one embodiment, the GMCH 1220 communicates with the processor(s) 1210, 1215 via a multi-drop bus, such as a frontside bus (FSB) 1295.

Furthermore, GMCH 1220 is coupled to a display 1245 (such as a flat panel display). GMCH 1220 may include an integrated graphics accelerator. GMCH 1220 is further coupled to an input/output (I/O) controller hub (ICH) 1250, which may be used to couple various peripheral devices to system 1200. Shown for example in the embodiment of FIG. 12 is an external graphics device 1260, which may be a discrete graphics device coupled to ICH 1250, along with another peripheral device 1270.

Alternatively, additional or different processors may also be present in the system 1200. For example, additional processor(s) 1215 may include additional processors(s) that are the same as processor 1210, additional processor(s) that are heterogeneous or asymmetric to processor 1210, accelerators (such as, e.g., graphics accelerators or digital signal processing (DSP) units), field programmable gate arrays, or any other processor. There can be a variety of differences between the physical resources 1210, 1215 in terms of a spectrum of metrics of merit including architectural, microarchitectural, thermal, power consumption characteristics, and the like. These differences may effectively manifest themselves as asymmetry and heterogeneity amongst the processing elements 1210, 1215. For at least one embodiment, the various processing elements 1210, 1215 may reside in the same die package.

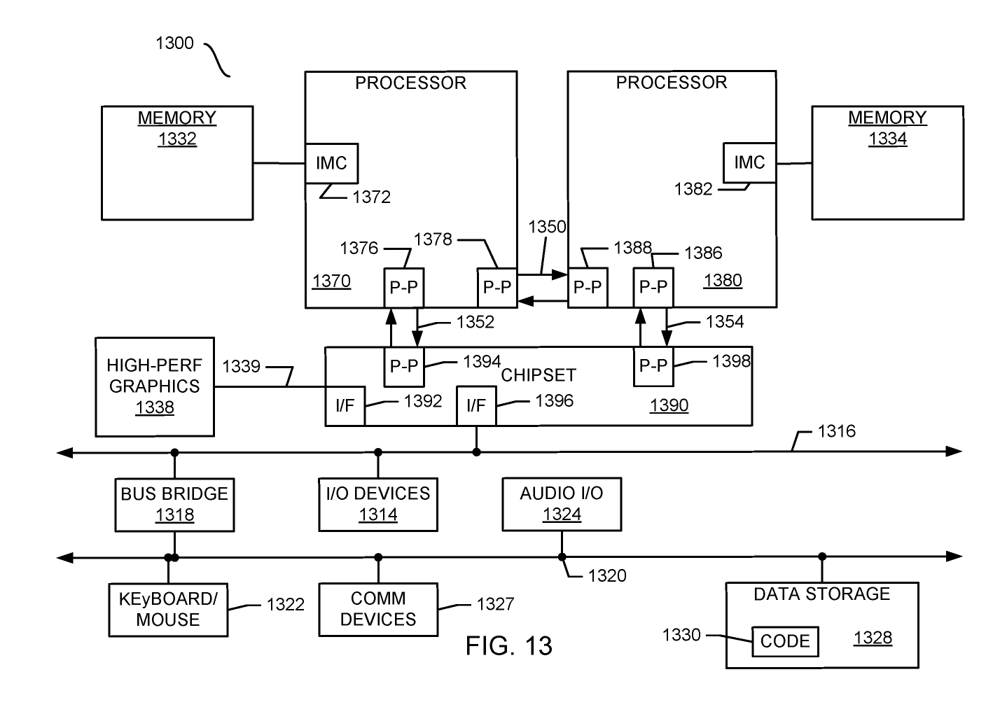

Referring now to FIG. 13, shown is a block diagram of a second system 1300 in accordance with an embodiment of the present invention. As shown in FIG. 13, multiprocessor system 1300 is a point-to-point interconnect system, and includes a first processor 1370 and a second processor 1380 coupled via a point-to-point interconnect 1350. As shown in FIG. 13, each of processors 1370 and 1380 may be some version of the processor 1600.

Alternatively, one or more of processors 1370, 1380 may be an element other than a processor, such as an accelerator or a field programmable gate array.

While shown with only two processors 1370, 1380, it is to be understood that the scope of the present invention is not so limited. In other embodiments, one or more additional processing elements may be present in a given processor.

Processor 1370 may further include an integrated memory controller hub (IMC) 1372 and point-to-point (P-P) interfaces 1376 and 1378. Similarly, second processor 1380 may include a IMC 1382 and P-P interfaces 1386 and 1388. Processors 1370, 1380 may exchange data via a point-to-point (PtP) interface 1350 using PtP interface circuits 1378, 1388. As shown in FIG. 13, IMC's 1372 and 1382 couple the processors to respective memories, namely a memory 1342 and a memory 1334, which may be portions of main memory locally attached to the respective processors.

Processors 1370, 1380 may each exchange data with a chipset 1390 via individual P-P interfaces 1352, 1354 using point to point interface circuits 1376, 1394, 1386, 1398. Chipset 1390 may also exchange data with a high-performance graphics circuit 1338 via a high-performance graphics interface 1339.

A shared cache (not shown) may be included in either processor outside of both processors, yet connected with the processors via P-P interconnect, such that either or both processors' local cache information may be stored in the shared cache if a processor is placed into a low power mode.

Chipset 1390 may be coupled to a first bus 1316 via an interface 1396. In one embodiment, first bus 1316 may be a Peripheral Component Interconnect (PCI) bus, or a bus such as a PCI Express bus or another third generation I/O interconnect bus, although the scope of the present invention is not so limited.

As shown in FIG. 13, various I/O devices 1314 may be coupled to first bus 1316, along with a bus bridge 1318 which couples first bus 1316 to a second bus 1320. In one embodiment, second bus 1320 may be a low pin count (LPC) bus. Various devices may be coupled to second bus 1320 including, for example, a keyboard/mouse 1322, communication devices 1327 and a data storage unit 1328 such as a disk drive or other mass storage device which may include code 1330, in one embodiment. Further, an audio I/O 1324 may be coupled to second bus 1320. Note that other architectures are possible. For example, instead of the point-to-point architecture of FIG. 13, a system may implement a multi-drop bus or other such architecture.

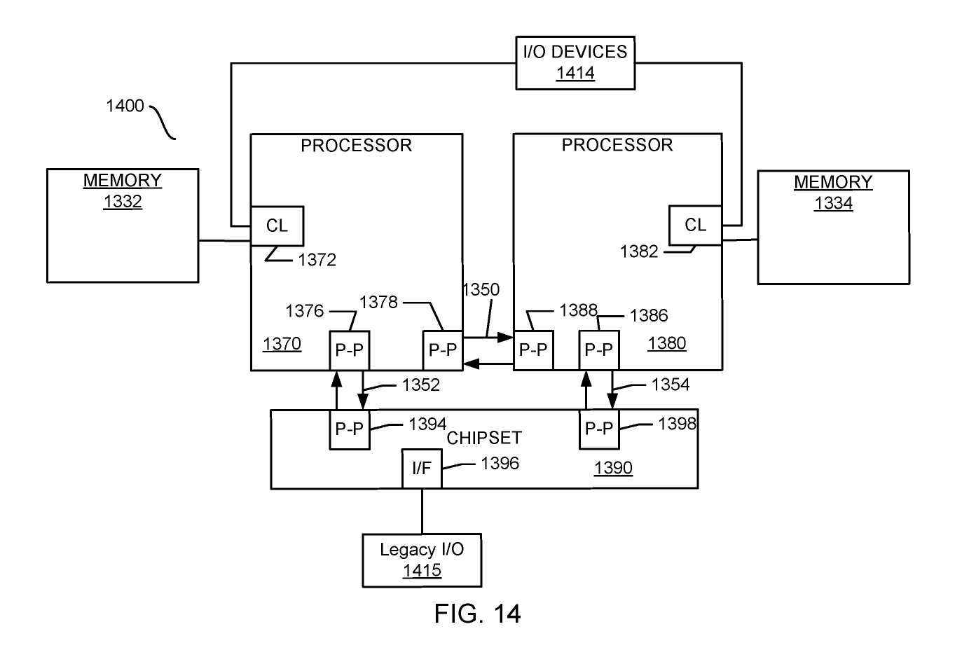

Referring now to FIG. 14, shown is a block diagram of a third system 1400 in accordance with an embodiment of the present invention. Like elements in FIGS. 13 and 14 bear like reference numerals, and certain aspects of FIG. 13 have been omitted from FIG. 14 in order to avoid obscuring other aspects of FIG. 14.

FIG. 14 illustrates that the processing elements 1370, 1380 may include integrated memory and I/O control logic (“CL”) 1372 and 1382, respectively. For at least one embodiment, the CL 1372, 1382 may include memory controller hub logic (IMC) such as that described above. In addition. CL 1372, 1382 may also include I/O control logic. FIG. 14 illustrates that not only are the memories 1342, 1334 coupled to the CL 1372, 1382, but also that I/O devices 1414 are also coupled to the control logic 1372, 1382. Legacy I/O devices 1415 are coupled to the chipset 1390.

Referring now to FIG. 15, shown is a block diagram of a SoC 1500 in accordance with an embodiment of the present invention. Similar elements in other figures bear like reference numerals. Also, dashed lined boxes are optional features on more advanced SoCs. In FIG. 15, an interconnect unit(s) 1502 is coupled to: an application processor 1510 which includes a set of one or more cores 1602A-N and shared cache unit(s) 1606; a system agent unit 1610; a bus controller unit(s) 1616; an integrated memory controller unit(s) 1614; a set or one or more media processors 1520 which may include integrated graphics logic 1608, an image processor 1524 for providing still and/or video camera functionality, an audio processor 1526 for providing hardware audio acceleration, and a video processor 1528 for providing video encode/decode acceleration; an static random access memory (SRAM) unit 1530; a direct memory access (DMA) unit 1532; and a display unit 1540 for coupling to one or more external displays.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code may be applied to input data to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks (compact disk read-only memories (CD-ROMs), compact disk rewritables (CD-RWs)), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the invention also include non-transitory, tangible machine-readable media containing instructions the vector friendly instruction format or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

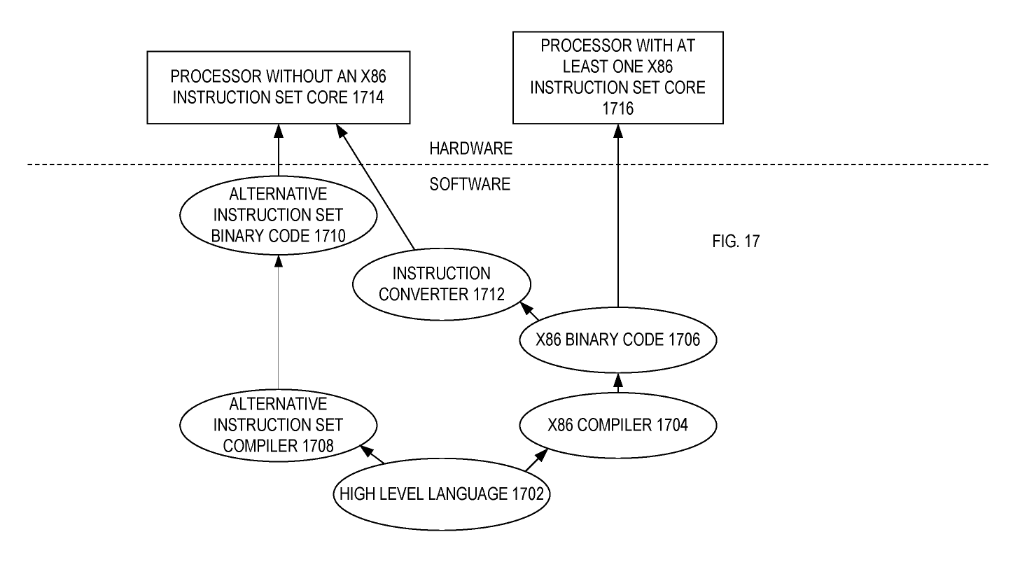

FIG. 17 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 17 shows a program in a high level language 1702 may be compiled using an x86 compiler 1704 to generate x86 binary code 1706 that may be natively executed by a processor with at least one x86 instruction set core 1716 (it is assume that some of the instructions that were compiled are in the vector friendly instruction format). The processor with at least one x86 instruction set core 1716 represents any processor that can perform substantially the same functions as a Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1704 represents a compiler that is operable to generate x86 binary code 1706 (e.g., object code) that can, with or without additional linkage processing, be executed on the processor with at least one x86 instruction set core 1716. Similarly, FIG. 80 shows the program in the high level language 1702 may be compiled using an alternative instruction set compiler 1708 to generate alternative instruction set binary code 1710 that may be natively executed by a processor without at least one x86 instruction set core 1714 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1712 is used to convert the x86 binary code 1706 into code that may be natively executed by the processor without an x86 instruction set core 1714. This converted code is not likely to be the same as the alternative instruction set binary code 1710 because an instruction converter capable of this is difficult to make; however, the converted code will accomplish the general operation and be made up of instructions from the alternative instruction set. Thus, the instruction converter 1712 represents software, firmware, hardware, or a combination thereof that, through emulation, simulation or any other process, allows a processor or other electronic device that does not have an x86 instruction set processor or core to execute the x86 binary code 1706.

Certain operations of the instruction(s) in the vector friendly instruction format disclosed herein may be performed by hardware components and may be embodied in machine-executable instructions that are used to cause, or at least result in, a circuit or other hardware component programmed with the instructions performing the operations. The circuit may include a general-purpose or special-purpose processor, or logic circuit, to name just a few examples. The operations may also optionally be performed by a combination of hardware and software. Execution logic and/or a processor may include specific or particular circuitry or other logic responsive to a machine instruction or one or more control signals derived from the machine instruction to store an instruction specified result operand. For example, embodiments of the instruction(s) disclosed herein may be executed in one or more the systems of FIGS. 12-15 and embodiments of the instruction(s) in the vector friendly instruction format may be stored in program code to be executed in the systems. Additionally, the processing elements of these figures may utilize one of the detailed pipelines and/or architectures (e.g., the in-order and out-of-order architectures) detailed herein. For example, the decode unit of the in-order architecture may decode the instruction(s), pass the decoded instruction to a vector or scalar unit, etc.

The above description is intended to illustrate preferred embodiments of the present invention. From the discussion above it should also be apparent that especially in such an area of technology, where growth is fast and further advancements are not easily foreseen, the invention can may be modified in arrangement and detail by those skilled in the art without departing from the principles of the present invention within the scope of the accompanying claims and their equivalents. For example, one or more operations of a method may be combined or further broken apart.

Alternative Embodiments

While embodiments have been described which would natively execute the vector friendly instruction format, alternative embodiments of the invention may execute the vector friendly instruction format through an emulation layer running on a processor that executes a different instruction set (e.g., a processor that executes the MIPS instruction set of MIPS Technologies of Sunnyvale, Calif., a processor that executes the ARM instruction set of ARM Holdings of Sunnyvale, Calif.). Also, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

In the description above, for the purposes of explanation, numerous specific details have been set forth in order to provide a thorough understanding of the embodiments of the invention. It will be apparent however, to one skilled in the art, that one or more other embodiments may be practiced without some of these specific details. The particular embodiments described are not provided to limit the invention but to illustrate embodiments of the invention. The scope of the invention is not to be determined by the specific examples provided above but only by the claims below.

What is claimed is:

1. A system comprising:
a system memory to store instructions and data; and
a first processor coupled to the system memory, the first processor to process a first type of instructions;
a second processor coupled to the first processor over an on-chip interconnect, the second processor to process a second type of instructions, the second processor comprising:
a plurality of 512-bit vector registers including:
a first source vector register to store a first plurality of data elements;
a second source vector register to store a second plurality of data elements, each of the second plurality of data elements to be stored in a data element location in the second source vector register corresponding to a data element location of one of the first plurality of data elements in the first source vector register; and
a destination vector register to store a blended combination of the first and second pluralities of data elements;
a plurality of vector mask registers including a source vector mask register, the source vector mask register to store predicate data comprising a plurality of bits, a value of each bit of the plurality of bits to identify one of the first plurality of data elements or one of the second plurality of data elements;
a decoder to decode an instruction specifying a data blend operation; and
execution circuitry to perform the data blend operation, the execution circuitry to select a packed data element from the first plurality of data elements to be stored in a corresponding location in the destination vector register if a corresponding bit of the predicate data has a first value and to select a packed data element from the second plurality of data elements to be stored in the corresponding location in the destination vector register if the corresponding bit of the predicate data has a second value a graphics processor to process graphics instructions, the graphics processor coupled to the first processor over the on-chip interconnect; and
an integrated memory controller to couple the first processor, the second processor, and the graphics processor to the system memory.

2. The system of claim 1, further comprising a storage device coupled to the first processor to store instructions and data.

3. The system of claim 1, further comprising an input/output (I/O) interconnect to couple the first processor to one or more I/O devices.

4. The system of claim 1, wherein the system memory comprises a dynamic random access (DRAM) memory.

5. The system of claim 1, further comprising a graphics processor coupled to the first processor to perform graphics processing operations.

6. The system of claim 1, further comprising a network processor coupled to the first processor.

7. The system of claim 1, further comprising an audio input/output device coupled to the first processor.

8. The system of claim 1, further comprising a shared cache to be shared by the first processor and the second processor.

9. The system of claim 1, further comprising compression circuitry coupled to the first processor.

10. The system of claim 1, wherein the first processor comprises a plurality of simultaneous multi-threaded (SMT) cores to simultaneously execute multiple threads including the first type of instructions.

11. The system of claim 10, wherein the second processor comprises a digital signal processor (DSP).

12. The system of claim 1, wherein the vector mask registers are smaller than 512-bits.

13. The system of claim 1, further comprising scalar execution circuitry to execute one or more scalar instructions, the scalar execution circuitry including a plurality of scalar registers.

14. The system of claim 1, further comprising a plurality of status registers to maintain data related to an execution state of the second processor.

15. A system comprising:
a system memory to store instructions and data, wherein the system memory comprises a dynamic random access (DRAM) memory; and
a first processor coupled to the system memory, the first processor to process a first type of instructions;
a second processor coupled to the first processor over an on-chip interconnect, the second processor to process a second type of instructions, wherein the second processor comprises a digital signal processor (DSP), the second processor comprising:
a plurality of 512-bit vector registers including:
a first source vector register to store a first plurality of data elements;
a second source vector register to store a second plurality of data elements, each of the second plurality of data elements to be stored in a data element location in the second source vector register corresponding to a data element location of one of the first plurality of data elements in the first source vector register; and
a destination vector register to store a blended combination of the first and second pluralities of data elements;
a plurality of vector mask registers including a source vector mask register, the source vector mask register to store predicate data comprising a plurality of bits, a value of each bit of the plurality of bits to identify one of the first plurality of data elements or one of the second plurality of data elements;
a decoder to decode an instruction specifying a data blend operation; and
execution circuitry to perform the data blend operation, the execution circuitry to select a packed data element from the first plurality of data elements to be stored in a corresponding location in the destination vector register if a corresponding bit of the predicate data has a first value and to select a packed data element from the second plurality of data elements to be stored in the corresponding location in the destination vector register if the corresponding bit of the predicate data has a second value
a shared cache to be shared by the first processor and the second processor
a graphics processor to process graphics instructions, the graphics processor coupled to the first processor over the on-chip interconnect;
an integrated memory controller to couple the first processor, the second processor, and the graphics processor to the system memory; and
a network processor coupled to the first processor.
